(19) United States
(12) Patent Application Publication
(10) Pub. No.: US 2025/0391236 A1
(43) Pub. Date: Dec. 25, 2025

(54) LINKED DIGITAL GAMES SYSTEM

(71) Applicant: FDJ GAMING SOLUTIONS FRANCE, BOULOGNE-BILLANCOURT (FR)

(72) Inventors: Antoine MAILLET, COURBEVOIE (FR); Cédric MARCADIER, ISSY LES MOULINEAUX (FR); Emeric HAMON, RENNES (FR)

(21) Appl. No.: 18/878,869

(22) PCT Filed: Jul. 3, 2023
(86) PCT No.: PCT/FR2023/051015

§ 371 Date: Dec. 24, 2024

(30) Foreign Application Priority Data
Jul. 1, 2022 (EP) 22305991.6
Jul. 6, 2022 (FR) FR2206910

(51) Int. Cl. G07F 17/32

(52) U.S. Cl. CPC G07F 17/3227; G07F 17/329

(57) ABSTRACT

A set for linked digital games, including at least one server cooperating with at least one game device. The gaming device is configured to participate in a first game and in a second game, the first and second games being different. The server includes a first software module implementing the first game and a second software module implementing the second game. The first and second software modules being distinct from one another. The server further includes a linked games management software module configured to execute the second software module after execution of the first software module.

The invention relates to the field of instantaneous digital lottery games, the participation in which could give access (for example in case of a losing result) to participation in a second game such as an instantaneous digital jackpot game (of the “1 chance to win out of N” type), and to the implementation of such linked games on computer servers. In the following text, it will be said that the digital lottery game and the digital jackpot game to which it opens access, are linked games.

An object of the present invention is to simplify the development and the implementation of linked games, in particular instantaneous digital lottery games and instantaneous digital jackpot games. The invention also enables the implementation of multi-jurisdictional jackpot games, i.e. jackpots linked to games belonging to lotteries dependent on several jurisdictions.

### DISCLOSURE OF THE INVENTION

To this end, the invention provides a linked digital games system.

Thus, a set for linked digital games is provided comprising at least one server cooperating with at least one gaming device, according to which the at least one gaming device is configured to participate in first and second games, the first and second games being different, said at least one server comprising a first software module implementing said first game and a second software module implementing said second game, said first and second software modules being distinct, said at least one server further comprising a linked games management software module, said linked games management software module is configured to execute said second software module after execution of said first software module.

Thus, the method according to the invention allows simplifying and reducing the costs of development and implementation of linked games.

According to particular embodiments, the set cooperates with a plurality of gaming devices, said at least one gaming device being a first gaming device, a second gaming device being configured to participate in third and second games, the third game being different from the first and second games, said at least one server comprising a third software module implementing said third game, said third software module being distinct from said first and second software modules, said linked games management software module being further configured to execute said second software module after execution of said third software module.

Still according to particular embodiments, said first and second gaming devices comprise software modules configured to enable a user to validate participation in said first game, respectively in said third game, and said validation of a participation in said first game, respectively said third game, comprises the transmission of a piece of participation information to said linked games management software module, said linked games management software module being configured to execute said first software module, respectively said third software module, in response to the reception of said participation information.

Still according to particular embodiments, the linked games management software module is further configured to manage a participation contribution in said first and second games, respectively in said third and second games.

Still according to particular embodiments, said second software module is configured to automatically transmit information from said second game to said first and second gaming devices.

Still according to particular embodiments, said set comprises said plurality of gaming devices, said first and second gaming devices comprising a graphical interface configured to display said information of said third game.

Still according to particular embodiments, said first software module transmits a piece of execution information to said linked games management software module when it is executed.

Still according to particular embodiments, said first set is a digital lottery game and said second game is a digital jackpot game.

Still according to particular embodiments, said at least one server comprises a plurality of linked games management software modules.

Still according to particular embodiments, said set comprises a plurality of servers, said first software module and said linked games management software module being executed on distinct servers.

### BRIEF DESCRIPTION OF THE DRAWINGS

Other features, details and advantages of the invention will become apparent upon reading the detailed description hereinafter. This description is purely illustrative and should be read with reference to the appended drawings wherein:

FIG. 1 illustrates an example of an environment in which the invention could be implemented according to particular embodiments;

FIG. 2 illustrates an example of a graphical interface used on a device of a player to participate in linked games, herein an instantaneous digital lottery game and then an instantaneous digital jackpot game;

FIG. 3 illustrates a first example of a software architecture of a linked games system, according to embodiments of the invention, enabling a player to participate in a first game and, after having participated in the first game, in a second game

FIG. 4 illustrates an example of communication between application modules, an instantaneous game module, a linked games management module and a jackpot game management module such as those illustrated in FIG. 3;

FIG. 5 illustrates a second example of a software architecture of a linked games system, according to embodiments of the invention, enabling a player to participate in a first game and, after having participated in the first game, in a second game;

FIG. 6 illustrates a third example of a software architecture of a linked games system, according to embodiments of the invention, enabling a player to participate in a first game and, after having participated in the first game, in a second game;

FIG. 7 illustrates a first example of implementation of two linked games comprising distinct instantaneous games and a common jackpot game;

FIG. 8 illustrates a second example of implementation of two linked games comprising distinct instantaneous games and a common jackpot game;

FIG. 9 illustrates a third example of implementation of two linked games comprising distinct instantaneous games and a common jackpot game; and

FIG. 10 illustrates an example of a device that could be used to implement, at least partially, embodiments of the invention, in particular steps described with reference to FIGS. 2 to 9.

### DETAILED DESCRIPTION

According to particular embodiments of the invention, the software architecture used to implement linked games is organised into software modules enabling different linked games to be based on common modules. Furthermore, this architecture enables the use of common modules for linked games implemented in particular contexts, for example games implemented in distinct jurisdictions, for example with different currencies. For example, the linked games are instantaneous digital lottery games and instantaneous digital jackpot games. Thus, the same jackpot game can be linked to different lottery games, which reduces the development times and costs. Sharing the same jackpot game with several lottery games also allows increasing the won sum.

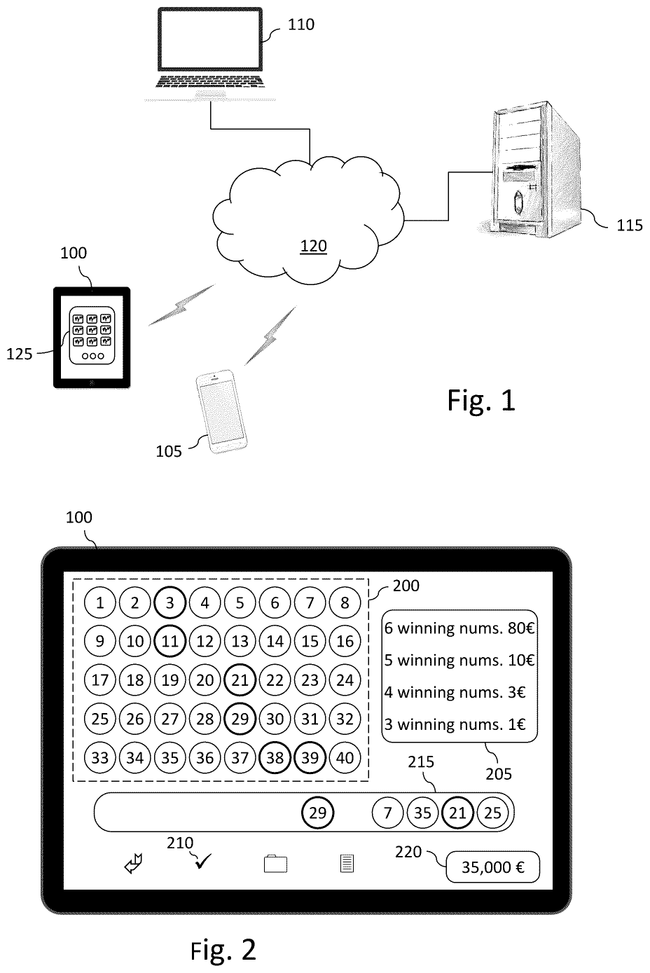

FIG. 1 illustrates an example of an environment in which the invention could be implemented according to particular embodiments. According to this example, a user can access linked games using a personal gaming device or a self-service gaming device, for example using a tablet 100, a smartphone 105 or a computer 110. In particular, this access may be performed after the player has connected to a player account created beforehand. In particular, such a player account allows purchasing a participation in an instantaneous digital lottery game. Some instantaneous digital lottery games offer the right to participate in an instantaneous digital jackpot game. In this case, according to some embodiments, a portion of the sum allocated to the instantaneous digital game is debited to supply the considered jackpot, and after participation in the instantaneous digital game, an instantaneous drawing of the jackpot is performed for the player. In general, the drawing is of the “1 chance to win out of N” type. It will be said that the instantaneous digital lottery game and the instantaneous digital jackpot game to which it allows access, are linked games.

Access to these games is herein proposed by a game operator on a server 115, via a communication network 120.

For illustration, access to the lottery game may be performed through a graphical interface, for example the interface 125, which may be a web interface or an interface of an application (app) installed on the device of the player and configured to interface with the corresponding game application, implemented on the server 115.

For example, the communication network 120 is the Internet network to which the devices 100, 105, 110 and 115 can connect using standard wired or wireless communication technologies, using known communication protocols.

It should be observed that the linked games can be implemented on one single server 115 or on several servers, for example in the form of software modules specific to each game. For example, lottery games may be implemented through software modules installed on a first server and the jackpot game may be implemented through a software module installed on another server. the lottery games may also be implemented through software modules installed on different servers.

Similarly, the lottery games and the jackpot games may be implemented by distinct game operators. Thus, for example, a first lottery game and an associated jackpot game may be implemented on a first server and proposed by a first game operator and a second lottery game may be implemented on a second server and be associated with the jackpot game implemented on the first server, the second lottery game and the associated jackpot game being proposed by a second game operator.

FIG. 2 illustrates an example of a graphical interface used on a gaming device of a player, for example the tablet 100 of FIG. 1, to participate in linked games, herein an instantaneous digital lottery game and then an instantaneous digital jackpot game.

As illustrated, the graphical interface comprises a first area 200 enabling a user to select several numbers, for example six numbers between one and forty. The selected numbers are those surrounded by a thicker line. The graphical interface also comprises a second area 205 in which the potential wins are displayed and a validation button 210 allowing validating the selected numbers and, thus, validating the purchase of the linked games comprising a participation in the lottery game for which a player has just selected the played numbers and a participation in a jackpot game. As soon as the validation is performed, an instantaneous draw is carried out. According to the illustrated example, six numbers between one and forty are drawn and displayed one after another in a result window 215 (only the first five numbers are herein drawn, among which two have been selected by the player who thus could save 1 € if the lastly drawn number is a played number). As soon as the player has participated in the lottery game, he/she is offered to participate in the jackpot game. Alternatively, he/she automatically participates as soon as he/she has played the lottery game. As illustrated, the amount of the jackpot associated with the lottery game in which the player participates is displayed in the display area 220. Preferably, it is updated automatically.

For example, the game engines corresponding to the lottery game and to the jackpot game are implemented in the server 115 of FIG. 1.

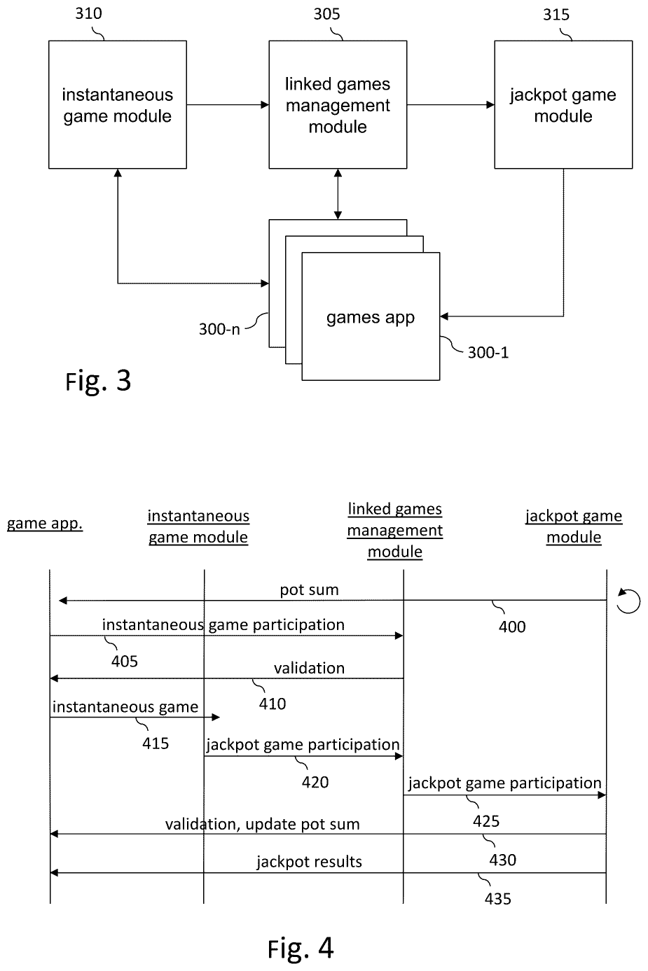

FIG. 3 illustrates a first example of a software architecture of a linked games system, according to embodiments of the invention, enabling a player to participate in a first game and, after having participated in the first game, in a second game.

As illustrated, the games system herein comprises several software modules, in particular application modules or app 300-1 to 300-n (generically referenced 300), intended to be implemented in each of the devices used by the players to participate. In particular, they may comprise an interface enabling a player to interact with the games system, in particular to participate in a first game, for example a lottery game as described with reference to FIG. 2. These application modules are specific to one or more particular game(s), for example one or more lottery game(s) and the associated jackpot games.

The application modules 300 are connected to a linked games management module 305 which is intended in particular to manage the participations of the players, in particular to manage the payments and the distribution of these payments between the linked games (preferably in a manner transparent for the player). It is also intended to trigger the participation in the second game, for example a jackpot game, after the player has participated in the first game, for example a lottery game.

The application modules 300 are also connected to a game module 310 to enable a player to participate in the first game, for example to select and validate numbers of a lottery game as described with reference to FIG. 2. This game module is so-called instantaneous game module. The instant game module 310 receives the participation information of the player, for example the selected numbers, and executes the corresponding game. For illustration, the instantaneous game module 310 can randomly draw numbers, compare them with numbers selected by a player and determine a result of the game. As illustrated, the instantaneous game module 310 is also connected to the linked games management module 305, in particular to inform it on the participation of a player in the game implemented by the instantaneous game module 310 and, where appropriate, to trigger a participation in the second game.

The application modules 300 are also connected to a game module 315 to enable a player to participate in the second game, for example to enable him/her to receive a sum of a jackpot game pot and, where appropriate, a won sum. This game module is so-called jackpot game module. The jackpot game module 315 can manage the participation of players in a jackpot game as well as the jackpot. Different rules may be used to manage the pot with regards to the participations of the players, for example progressively (the sum of the pot increases proportionally to the sum of the participations), incrementally (the sum of the pot increases in increments according to the sum of the participations), in a fixed manner (the sum is fixed and determined), etc. As illustrated, the jackpot game module 315 is also connected to the linked games management module 305, in particular to enable the linked games management module 305 to trigger the participation of a player in the second game.

The links between the modules 300, 305, 310 and 315 are links enabling data exchanges and triggering of participation in a game. They may use standard communication protocols.

FIG. 4 illustrates an example of communication between application modules, an instantaneous game module, a linked games management module and a jackpot game management module, such as the software modules illustrated in FIG. 3.

A first step (step 400) is herein intended to transmit a piece of information relating to a second game, for example a pot sum of a jackpot game, between a jackpot game module, for example the jackpot game module 315 of FIG. 3, to application modules, for example the application modules 300 of FIG. 1. As illustrated, this step is repeated, for example as soon as the sum of the pot changes or as soon as the variation exceeds a particular threshold.

In a next step, after a player has validated a participation in a first game linked to a second game a piece of information of which might have been received, for example a lottery game as described with reference to FIG. 2, a request to participate in the first game is transmitted (step 405) from the application module implemented in the device used by the player to a linked games management module, for example the linked games management module 305 of FIG. 3. Preferably, this request comprises information on the player, in particular information allowing debiting a sum corresponding to his participation in the linked games. According to particular embodiments, in response to the reception of a participation request, the linked games management module obtains the payment of the player (directly or via a third party) and assigns a portion to the instantaneous game and a portion to the jackpot game according to predetermined rules stored in the module itself or to which it has access. The sum of the participation may be transmitted in the request or may be known to the linked games management module. After having obtained the payment of the player, the linked games management module sends to the application module implemented in the device used by the player a piece of information validating the participation in the first game (step 410).

After having received a piece of information validating the participation in the first game, the application module implemented in the device used by the player sends a request to participate in a game module enabling the implementation of the first game, for example the instantaneous game module 310 of FIG. 3 (step 415). Preferably, this request comprises the game parameters, for example numbers selected by the player to participate in the game. The game module enabling the implementation of the first game then executes the game. For illustration, the game module enabling the implementation of the first game proceeds with a random draw and compares the result of this draw with a selection performed by the player to participate in the game.

In a next step, the game module enabling the implementation of the first game sends a piece of information to the linked games management module to inform it/her on the participation of the player in the first game (step 420). In response, the linked games management module sends a request to the jackpot game module to request the participation of the player in the jackpot game (step 425). For example, this request comprises an indication relating to the identity of the player and a participation sum. Upon reception of this request, the jackpot game module records the participation of the player and updates the sum of the pot. As indicated before, the updated sum of the pot is preferably transmitted to the application modules (step 430). When the jackpot game module performs the drawing, for example according to predetermined rules (for example on a predetermined date), it informs the winner(s) or all players having participated in the jackpot (step 435).

As described before, the instantaneous game module, the games management module and the jackpot game module may be implemented in one single server or in several servers. Depending on the configuration, the communication between these modules is carried out within the same server or via a communication network, for example using standard communication protocols.

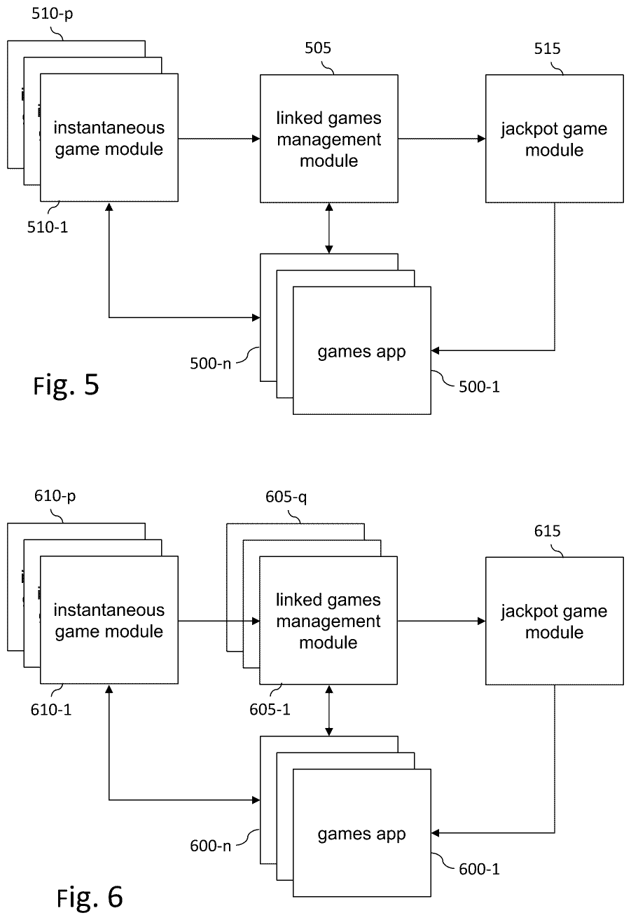

FIG. 5 illustrates a second example of a software architecture of a linked games system, according to embodiments of the invention, enabling a player to participate in a first game and, after having participated in the first game, in a second game.

According to this example, several different first games, for example several different first instantaneous games, may be associated with the same second game, for example with the same jackpot game.

Again, as illustrated, the games system herein comprises application modules or app 500-1 to 500-n (generically referenced 500), intended to be implemented in each of the devices used by the players to participate. In particular, they comprise an interface enabling a player to interact with the games system, in particular to participate in the first game, for example a lottery game as described with reference to FIG. 2. These application modules are specific to one or more particular game(s), for example one or more lottery game(s) and the associated jackpot games.

The application modules 500 are connected to a linked games management module 505 which is intended in particular to manage the participations of the players, in particular to manage the payments and the distribution of these payments between the linked games (in a manner transparent for the player). It is also intended to trigger the participation in the second game, for example a jackpot game, after the player has participated in a first game, for example a lottery game.

The application modules 500 are also connected to one or more game module(s) 510-1 to 510-p, preferably independent of one another, generically referenced 510, to enable a player to participate in a first game of his/her choice amongst the first games proposed by the application module installed on the device that he/she uses, for example selecting and validating numbers of a lottery game as described with reference to FIG. 2. The selected instantaneous game module receives the participation information from the player, for example the selected numbers, and executes the corresponding game. Again, the instantaneous game modules 510 are connected to the linked games management module 505, in particular to inform it of a participation of a player in a game implemented by an instantaneous game module 510 and, where appropriate, to trigger a participation in the second game.

The application modules 500 are also connected to a game module 515 to enable a player to participate in the second game, for example to enable him/her to receive a sum of a jackpot game pot and, where appropriate, a won sum. Like the jackpot game module 315, the jackpot game module 515 can manage the participation of players in a jackpot game as well as the pot. Similarly, the jackpot game module 515 is also connected to the linked games management module 505, in particular to enable the linked games management module 505 to trigger the participation of a player in the second game.

FIG. 6 illustrates a third example of a software architecture of a linked games system, according to embodiments of the invention, enabling a player to participate in a first game and, after having participated in the first game, in a second game.

According to this example, several different first games, for example several different first instantaneous games, may be associated with the same second game, for example with the same jackpot game. As illustrated, this software architecture implements several linked games management modules, thereby allowing easily implementing games in different places with different legislations and/or currencies

Again, as illustrated, the game system herein comprises application modules or app 600-1 to 600-n (generically referenced 600), intended to be implemented in each of the devices used by the players to participate. In particular, they comprise an interface enabling a player to interact with the games system, in particular to participate in the first game, for example a lottery game as described with reference to FIG. 2. These application modules are specific to one or more particular game(s), for example one or more lottery game(s) and the associated jackpot games.

Each of the application modules 600 is connected to a linked games management module amongst the linked games management modules 605-1 to 605-q, generically referenced 605, identified according to the used application module, for example according to a geographical location of the device implementing the considered application module or according to a subscription location of a player. In particular, each of the linked games management modules is intended to manage the participations of the players, in particular to manage the payments and the distribution of these payments between the linked games (in a manner transparent for the player). It is also intended to trigger the participation in the second game, for example a jackpot game, after the player has participated in a first game, for example a lottery game. Each of the linked games management modules may also be configured to perform conversions, for example convert a participation in the second game with a local currency into a reference unit used by the second game and vice versa, as described hereinbelow.

The application modules 600 are also connected to one or more game module(s) 610-1 to 610-p, preferably independent of one another, generically referenced 610, to enable a player to participate in a first game of his/her choice amongst the first games proposed by the application module installed on the device that he/she uses, for example to select and validate numbers of a lottery game as described with reference to FIG. 2. The selected instantaneous game module receives the participation information from the player, for example the selected numbers, and executes the corresponding game. Again, the instantaneous game modules 610 are connected to a linked games management module 605, in particular to inform it of a participation of a player in a game implemented by an instantaneous game module 610 and, where appropriate, to trigger a participation in the second game.

The application modules 600 are also connected to a game module 615 to enable a player to participate in the second game, for example to enable him/her to receive a sum of a jackpot game pot and, where appropriate, a won sum. Like the jackpot game module 315, the jackpot game module 615 can manage the participation of players in a jackpot game as well as the pot. Similarly, the jackpot game module 615 is also connected to a linked games management module 605, in particular to enable the linked games management module 605 to trigger the participation of a player in the second game.

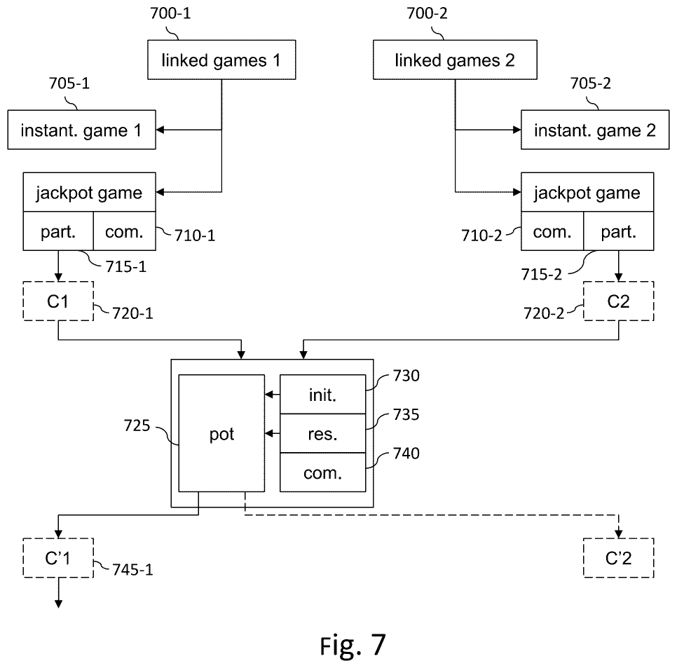

FIG. 7 illustrates a first example of implementation of two linked games comprising distinct instantaneous games and a common jackpot game.

As illustrated, participation in a first set of linked games, for example through one single purchase of a first sum referenced 700-1, herein allows participating in a first instantaneous game for a first fraction of the sum of the first set of linked games, referenced 705-1, and participating in a jackpot game for a second fraction of the sum of the first set of linked games. This second fraction itself could be split into a commission for the game operator managing the first set of linked games, referenced 710-1, and a second portion object of the jackpot game, managed by the same game operator or by another one, referenced 715-2.

According to particular embodiments, the second portion object of the jackpot game is converted into game units, for example into tokens, according to a fixed or variable conversion coefficient or rate, referenced 720-1. For example, in the case where players using different currencies can participate in the same jackpot game, a reference coefficient may be defined for one of the currencies so-called the reference currency (for example, twenty tokens correspond to one euro) and estimated rates, based for example on a history of exchange rates, comprising a risk margin, may be used for the other currencies. Thus, the price of the game units or tokens is predetermined for all players.

The second portion object of the jackpot game, where appropriate converted into game units or tokens, is then decomposed, for example, according to predetermined ratios, for example, to supply the pot of the jackpot game, referenced 725, to supply an initialisation fund used to create a base pot when a new jackpot is created after one or more player(s) has/have gained, referenced 730, to supply a reserve fund that could be used in case of difficulty by the operator of the jackpot game or to exceptionally supply the pot, referenced 735, and/or to finance the jackpot game operator in the form of a commission referenced 740.

If, after drawing, a player having participated in the first set of linked games wins the jackpot, an inverse coefficient, referenced 745-1, may be applied, in particular if the second portion object of the jackpot game has been converted into game units or tokens. If the sum of the jackpot should be converted into the reference currency, a coefficient inverse to that one used to convert the second portion object of the jackpot game into game units or tokens may be applied. On the contrary, if the sum of the jackpot that is won should be converted into a currency other than the reference currency, the used coefficient may be based on the change rate (with respect to the reference currency) on the day of the payment of the jackpot, while taking into account the conversion coefficient between the reference currency and the game units or tokens.

In the same manner, participation in a second set of linked games, for example through one single purchase of a first sum referenced 700-2, herein allows participating in a second instantaneous game, different from the first instantaneous game, for a first fraction of the sum of the second set of linked games, referenced 705-2 and participating in the jackpot game for a second fraction of the sum of the second set of linked games. Again, this second fraction itself may be split into a commission for the game operator managing the second set of linked games, referenced 710-2, and a second portion object of the jackpot game, managed by the same game operator or by another one, referenced 715-2.

Similarly, the second portion object of the jackpot game may be converted into game units, for example into tokens, according to a fixed or variable conversion coefficient or rate, referenced 720-2. The second portion object of the jackpot game, where appropriate converted into game units, is split to supply the pot of the jackpot game, referenced 725, to supply an initialisation fund used to create a base pot when a new jackpot is created after one or more player(s) has/have won, referenced 730, to supply a reserve fund that could be used in case of difficulty by the operator of the jackpot game or to exceptionally supply the pot, referenced 735, and/or to financer the jackpot game operator in the form of a commission referenced 740.

For illustration, the operator of the jackpot game can herein implement a jackpot game module like one of the jackpot game modules 515 and 615 described with reference to FIGS. 5 and 6. It can also implement a linked games management module like one of the linked games management modules 505 and 605 described with reference to FIGS. 5 and 6. The game operators of the first and second sets of linked games can implement instantaneous games modules like the instantaneous games modules 505 and 605 described with reference to FIGS. 5 and 6. They can also implement linked games management modules like the linked games management modules 505 and 605 described with reference to FIGS. 5 and 6.

According to particular embodiments, when the game operators of the first and second sets of linked games implement linked games management modules like the linked games management modules 505 and 605 described with reference in FIGS. 5 and 6, the transfers of money to the jackpot game operator are performed only when the jackpot is won.

Still according to particular embodiments, the sum of the pot is calculated in the different currencies used, preferably using the change rate of the day, as described before, to indicate the sum that could potentially be won each day (as described with reference to steps 400 and 430 of FIG. 4).

Still according to particular embodiments, the jackpot game operator can combine several jackpots associated with the same instantaneous games, for example to propose several jackpots having different draw frequencies and sums.

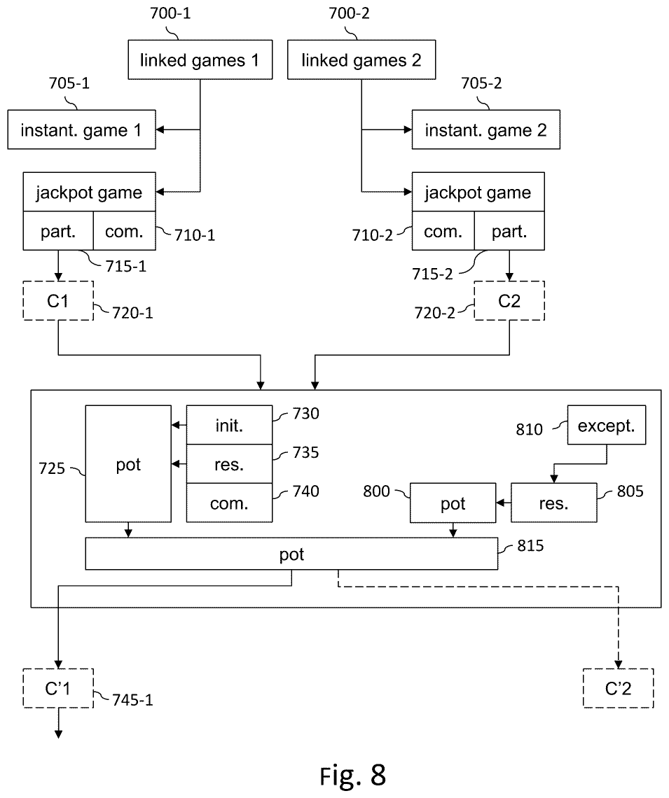

FIG. 8 illustrates a second example of implementation of two linked games comprising distinct instantaneous games and a common jackpot game.

The example illustrated in FIG. 8 is based on the example of FIG. 7, the same references designating the same elements. As illustrated in FIG. 8, a portion of the participation in the sets of linked games is used to supply a second pot of the jackpot game, referenced 800 and to supply a reserve fund 805. The second pot may also be supplied by the jackpot game operator, from an exceptional fund 810. The pot 800 could then be combined with the pot 725 to form the pot 815 related to the jackpot.

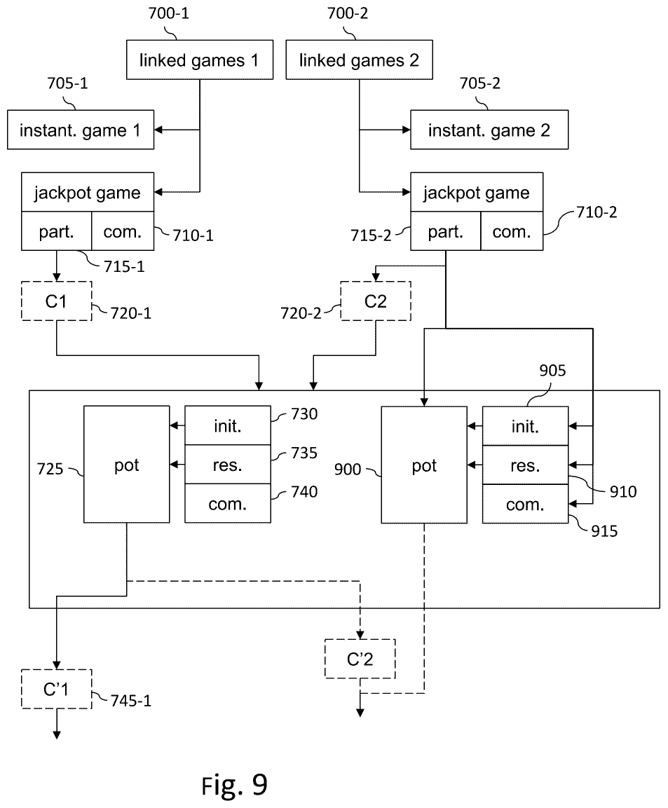

FIG. 9 illustrates a third example of implementation of two linked games comprising distinct instantaneous games and a common jackpot game.

The example illustrated in FIG. 9 is based on the example of FIG. 7, the same references designating the same elements. As illustrated in FIG. 9, part of the participation in the second set of linked games is used to supply a second pot of the jackpot game, referenced 900, supply an initialisation fund 905 and a reserve fund 910 specific to this second pot and to pay a commission 915 to the operator of the jackpot game. The second pot is specific to players participating in the linked games of the second set. According to the illustrated example, the second pot is managed in the currency of the game operator managing the second set of linked games. Alternatively, the second pot may be managed in game units or tokens.

According to the example illustrated in FIG. 9, a player participating in the first set of linked games participates only in the pot 725 while a player participating in the second set of linked games participates in the pot 725 as well as the pot 900, these two pots preferably being the object of different draws.

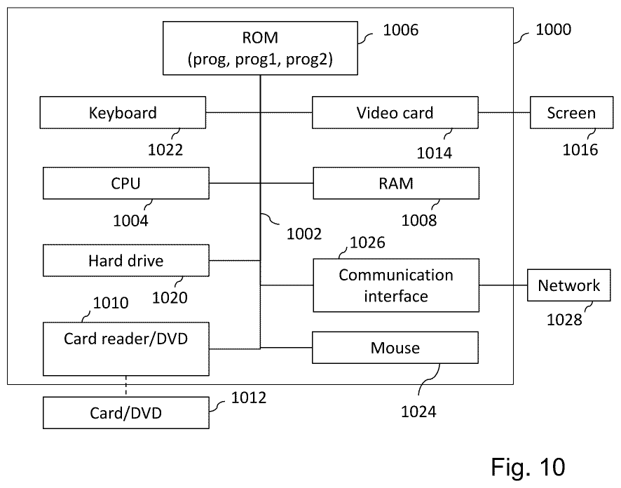

FIG. 10 illustrates an example of a device that can be used to implement, at least partially, embodiments of the invention, in particular steps described with reference to FIGS. 2 to 9.

For example, the device 1000 is a server, a computer or a terminal.

Preferably, the device 1000 includes a communication bus 1002 to which are connected:
a central processing unit or microprocessor 1004 (CPU, an acronym standing for Central Processing Unit in the Anglo-Saxon terminology);
a read-only memory 1006 (ROM, an acronym standing for Read Only Memory in the Anglo-Saxon terminology) which could include the operating system and programs such as “Prog”;
a random-access memory or cache memory 1008 (RAM, an acronym standing for Random Access Memory in the Anglo-Saxon terminology) including registers adapted to save variables and parameters created and modified during the execution of the aforementioned programs; and
a communication interface 1026 connected to a distributed communication network 1028, for example a wireless communication network and/or a local communication network, the interface being able to transmit and receive data, in particular to and from a device of a user.

Optionally, the device 1000 may also have the following elements:
a hard drive 1020 which could include the aforementioned programs “Prog” and data processed or to be processed according to the invention;
a keyboard 1022 and a mouse 1024 or any other pointing device like a light pen, a touchscreen or a remote control enabling the user to interact with the programs according to the invention;
a reader 1010 of a removable storage medium 1012 such as a memory card or a disk, for example a DVD disk; and
a graphics card 1014 connected to a screen 1016.

The communication bus enables the communication and the interoperability between the different elements included in the device 1000 or connected thereto. The representation of the bus is not restrictive and, in particular, the central unit could communicate instructions to any element of the device 1000 directly or via another element of the device 1000.

The executable code of each program enabling the programmable device to implement the processes according to the invention may be stored, for example, in the hard drive 1020 or in the read-only memory 1006.

According to an alternative embodiment, the executable code of the programs could be received by means of the communication network 1028, via the interface 1026, in order to be stored in a manner identical to the previously-described one.

More generally, the program(s) could be loaded into one of the storage means of the device 1000 before being executed.

The central unit 1004 will control and direct the execution of the software code instructions or portions of the program(s) according to the invention, which instructions are stored in the hard drive 1020 or in the read-only memory 1006 or in the other aforementioned storage elements. Upon start-up, the program(s) that is/are stored in a non-volatile memory, for example the hard drive 1020 or the read-only memory 1006, is/are transferred into the random-access memory 1008 which then contains the executable code of the program(s) according to the invention, as well as registers for storing the variables and parameters necessary for the implementation of the invention.

Although embodiments of the invention have been explained in the context of games, it is not limited to this context.

Depending on the selected embodiment, some acts, actions, events or functions of each of the methods described in the present document could be carried out or occur according to an order different to that one in which they have been described, or could be added, merged or not be performed or not occur, depending on the case. Furthermore, in certain embodiments, certain acts, actions or events are carried out or occur concurrently and not successively.

Although described through some detailed embodiments, the proposed method and the equipment for implementing the method comprise different variants, modifications and improvements which will appear in an obvious manner to a person skilled in the art, bearing in mind that these different variants, modifications and improvements fall within the scope of the invention. In addition, various aspects and features described hereinabove may be implemented together, or separately, or substitute one another, and all of the different combinations and sub-combinations of the aspects and features fall within the scope of the invention. Furthermore, it is possible that some systems and equipment described hereinabove do not incorporate all of the modules and functions described for the preferred embodiments.

1. A set for linked digital games comprising at least one server cooperating with at least one gaming device, according to which the at least one gaming device is configured to participate in first and second games, the first and second games being different, said at least one server comprising a first software module implementing said first game and a second software module implementing said second game, said first and second software modules being distinct, said at least one server further comprising a linked games management software module, said linked games management software module is configured to execute said second software module after execution of said first software module.

2. The set according to claim 1, cooperating with a plurality of gaming devices, said at least one gaming device being a first gaming device, according to which a second gaming device is configured to participate in a third game and the second game, the third game being different from the first and second games, said at least one server comprising a third software module implementing said third game, said third software module being distinct from said first and second software modules, said linked games management software module being further configured to execute said second software module after execution of said third software module.

3. The set according to claim 2, according to which said first and second gaming devices comprise software modules configured to enable a user to validate participation in said first game, respectively in said third game, and according to which said validation of a participation in said first game, respectively said third game, comprises the transmission of a piece of participation information to said linked games management software module, said linked games management software module being configured to execute said first software module, respectively said third software module, in response to the reception of said participation information.

4. The set according to claim 3, according to which the linked games management software module is further configured to manage a participation contribution in said first and second games, respectively in said third and second games.

5. The set according to claim 2, according to which said second software module is configured to automatically transmit information from said second game to said first and second gaming devices.

6. The set according to claim 5, comprising said plurality of gaming devices, according to which said first and second gaming devices comprise a graphical interface configured to display said information of said third game.

7. The set according to claim 1, according to which said first software module transmits a piece of execution information to said linked games management software module when it is executed.

8. The set according to claim 1, according to which said first set is a digital lottery game and said second game is a digital jackpot game.

9. The set according to claim 1, according to which said at least one server comprises a plurality of linked games management software modules.

10. The set according to claim 1, comprising a plurality of servers, said first software module and said linked games management software module being executed on distinct servers.
